(19) United States
(12) Patent Application Publication
(10) Pub. No.: US 2026/0359071 A1
(43) Pub. Date: Nov. 12, 2026

(54) SYSTEMS AND METHODS FOR AUTOMATED INFRASTRUCTURE CONFIGURATION USING A SEMANTIC MODEL AND TRANSLATION ENGINE

(71) Applicant: Warner Bros. Discovery, Inc., New York, NY (US)

(72) Inventors: Erik FORTUNE, Redmond, WA (US); Hazel DIANA MARY, New York, NY (US); Nathan MISCHE, Philadelphia, PA (US); Christopher RANDLES, New York, NY (US); Brett WAGNER, New York, NY (US)

(21) Appl. No.: 19/199,983

(22) Filed: May 6, 2025

(51) Int. Cl. G06F 9/445

(52) U.S. Cl. CPC G06F 9/44505

(57) ABSTRACT

A method for automating a configuration and deployment of infrastructure using a semantic model is disclosed. The method includes: defining, using a computer system, the semantic model; translating, using a processor associated with the computer system, the semantic model into infrastructure specifications; generating, from the infrastructure specifications, a deployment map representing a platform topology of physical deployments and characteristics of the physical deployments; generating, based on the deployment map, a sequence of deployment records, wherein each of the sequence of deployment records indicate a desired target component, a template, and one or more parameters to be inserted into one or more positions in a deployment template to reach a target outcome; inserting one or more configuration values derived from the sequence of deployment records into the one or more positions in the deployment template; and automating, based on the inserting, the deployment of the infrastructure.

### TECHNICAL FIELD

Various embodiments of the present disclosure relate generally to automated cloud infrastructure configuration and validation and, more particularly, to systems and methods for leveraging a semantic model-based interface for translating high-level infrastructure requirements into detailed, actionable specifications for automated deployment and validation.

### BACKGROUND

Currently, setting up application infrastructure across different cloud regions involves complex, manual configurations of various underlying services such as identity management, authorization, profiles, and cloud resources. These manual processes are error-prone, time-intensive, and hinder scalability. Traditional automation approaches typically rely on static configurations or templates or binaries that include all dependencies, which limits flexibility and increases maintenance overhead. There exists a need for a streamlined, automated mechanism that simplifies the infrastructure setup and validation process, particularly for globally distributed applications.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for automatically configuring infrastructure using a semantic model are provided.

In one aspect, a computer-implemented method for automating a configuration and deployment of infrastructure using a semantic model is disclosed. The computer-implemented method may include: defining, using a computer system, the semantic model; translating, using a processor associated with the computer system, the semantic model into infrastructure specifications; generating, using the processor and from the infrastructure specifications, a deployment map representing a platform topology of physical deployments and characteristics of the physical deployments; generating, using the processor and based on the deployment map, a sequence of deployment records, wherein each of the sequence of deployment records indicate a desired target component, a template, and one or more parameters to be inserted into one or more positions in a deployment template to reach a target outcome; inserting, using the processor, one or more configuration values derived from the sequence of deployment records into the one or more positions in the deployment template; and automating, based on the inserting, the deployment of the infrastructure.

In another aspect, a system is disclosed. The system may include: a memory including instructions; and at least one processor configured to execute the instructions stored in the memory to perform operations comprising: defining a semantic model; translating the semantic model into infrastructure specifications; generating, from the infrastructure specifications, a deployment map representing a platform topology of physical deployments and their characteristics; generating, based on the deployment map, a sequence of deployment wherein each of the sequence of deployment records indicate a desired target component, the template, and the parameters to be inserted to reach a target outcome; inserting one or more configuration values derived from the deployment record into one or more positions in a deployment template; and automating, based on the deployment template, deployment of the infrastructure.

In yet another aspect, a non-transitory computer-readable medium storing computer-executable instructions is disclosed. The non-transitory computer-readable medium, when executed by a server in network communication with at least one database, may cause the server to perform operations including: defining, using a computer system, a semantic model; translating, using a processor associated with the computer system, the semantic model into infrastructure specifications; generating, using the processor and from the infrastructure specifications, a deployment map representing a platform topology of physical deployments and characteristics of the physical deployments; generating, using the processor and based on the deployment map, a sequence of deployment records, wherein each of the sequence of deployment records indicate a desired target component, a template, and one or more parameters to be inserted into one or more positions in a deployment template to reach a target outcome; inserting, using the processor, one or more configuration values derived from the sequence of deployment records into the one or more positions in the deployment template; and automating, based on the inserting, the deployment of the infrastructure.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts components of an exemplary deployment map API architecture, according to one or more embodiments of the present disclosure.

FIG. 2 depicts a diagram illustrating the relationships and dependencies between various entities modeled using CRDs within the deployment map API system, according to one or more embodiments of the present disclosure.

FIG. 3 presents a process flow for implementing a high-level semantic model for infrastructure configuration, according to one or more embodiments of the present disclosure.

FIG. 4 depicts an exemplary computer server, according to one or more embodiments of the present disclosure.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

The term “user”, “subscriber,” and the like generally encompasses consumers who are subscribed to a streaming service (e.g., streaming platform) associated with the system described herein. The term “streaming service” (e.g., streaming platform) may refer to subscription-based video-on-demand (SVoD) services such as television shows, films, documentaries, and the like. The streaming service may also encompass user-facing cloud streaming services that may leverage various types of models for providing the streaming service (e.g., advertising-based video on demand (AVOD), transaction video on demand (TVOD), pay-per-view (PPV), and the like). The term “user” may be used interchangeably with “user profile,” “profile,” and the like throughout this application. The phrase “registered with” may be used interchangeably with “subscribed to” and the like throughout this application. The phrase “multimedia content” may be used interchangeably with “multimedia content item,” “article of multimedia content,” and the like throughout this application.

In the evolving landscape of cloud-based applications, the process of configuring infrastructure for new geographic markets or tenants is labor-intensive, complex, and error-prone. Deploying applications in diverse geographical regions requires setting up and coordinating numerous services such as user authentication, authorization, identity management, and cloud resources, all of which must work harmoniously to ensure consistent performance and compliance with local regulations. Each new market launch involves configuring these services to meet the specific requirements of the target region, a process that becomes increasingly unwieldy as applications scale globally. Infrastructure teams must manually define and deploy these services for each region, often coordinating with product teams that may not understand the intricacies of infrastructure requirements. This disconnect between product and infrastructure teams, along with the repetitive and manual nature of the setup, leads to longer setup times and increased risk of misconfigurations, as well as hampers the scalability of applications as they grow into new markets.

Traditional approaches to streamline this infrastructure setup process have primarily focused on creating static, predefined configurations, or “binaries,” that encapsulate the necessary setup for a given environment. These configurations are often manually curated lists of dependencies, services, and resources tailored for a specific product launch in a given market. By automating parts of this static list, teams have aimed to expedite deployments and reduce errors. However, this approach has notable limitations. Since each list is specific to a particular setup, any deviation, such as deploying to a new region or adjusting services, requires extensive manual reconfiguration. The predefined configurations are rigid and quickly become outdated as new markets are added, products are scaled, or as application requirements evolve. Further, traditional approaches lack flexibility to accommodate minor or incremental changes, such as launching an existing product in a similar yet distinct market. Additionally, the manual effort to create, maintain, and validate these configurations remains high, with errors or discrepancies often discovered only in late-stage testing or post-deployment.

To address one or more of the above-noted or other problems, the present disclosure presents a system that changes how infrastructure is provisioned, deployed and maintained, offering several advantages over conventional approaches. By decoupling the high-level specifications from the underlying infrastructure details, the system enables rapid, error-free deployment in new markets without requiring exhaustive, manual setup or rigid, predefined configurations. It also enhances scalability, as new regions, tenants, or services can be added by modifying high-level parameters rather than redesigning infrastructure blueprints. In an aspect, the semantic model provides a single source of truth for all configurations, ensuring consistency across deployments while maintaining flexibility to adapt to region-specific requirements or evolving business needs. The system also automates validation, detecting discrepancies between the desired and actual system states and allowing infrastructure to be rectified automatically or semi-automatically. This automation reduces human error, shortens deployment times, and frees up resources for other critical tasks, such as feature development and innovation.

The system described herein does not just inject values into predefined infrastructure configurations, but rather, is configured to determine what infrastructure components should exist in the first place. Specifically, unlike traditional automation systems that assume a fixed set of resources and focus on filling in missing configuration parameters, the novel system described herein leverages a semantic model to dynamically infer which services, resources, dependencies, etc., are necessary based on high-level business and operational requirements. The system may analyze the intent behind a deployment request and then derive a deployment map that explicitly defines what infrastructure elements must be provisioned. After establishing this foundational structure, the system may configure the components by injecting specific values. This approach ensures that infrastructure is not parameterized, but also intelligently generated, thereby allowing for greater flexibility, scalability, and compliance with operational demands. By decoupling infrastructure definitions from static templates, the novel system eliminates the need for manual adjustments when expanding to new regions, integrating new services, or adapting to regulatory changes, thereby transforming how cloud environments are deployed and managed.

The systems and methods described herein represent an improvement to computer technology by introducing a high-level semantic model for infrastructure configuration, a concept that elevates how cloud environments are deployed, managed, and scaled. Traditional infrastructure configuration methods rely on predefined, static templates that are manually created and maintained, often requiring extensive knowledge of infrastructure-specific details. This reliance on static configurations limits adaptability and imposes significant burdens on infrastructure teams, as each deployment must be tailored to specific regional requirements and product needs. By shifting to a model-driven approach, the novel system allows for the dynamic interpretation of high-level configurations, enabling systems to autonomously adapt infrastructure specifications based on simple, user-friendly inputs. This reduces the dependency on deep infrastructure expertise and allows diverse teams to interact with complex cloud configurations in a way that is accessible, flexible, and aligned with real-world, product-specific requirements.

From a technical standpoint, the ability of the system's translation engine to interpret and generate detailed infrastructure setups based on semantic inputs streamlines both the deployment and maintenance of applications in multi-tenant, globally distributed environments. By automating the conversion of high-level requirements into precise, executable configurations, the system minimizes manual interventions and reduces the risk of human error, which is particularly critical as applications scale and enter new markets. Additionally, this approach enhances scalability by allowing infrastructure to be configured and validated programmatically, ensuring consistency across deployments while accommodating necessary regional variations. Such automation represents an evolution in cloud management, where high-complexity tasks traditionally handled by infrastructure specialists are now managed by the system itself, optimizing resource allocation, improving reliability, and shortening time-to-market. Furthermore, the system introduces a single source of truth for infrastructure configurations, enhancing visibility and traceability within complex deployments. This source of truth not only aids in troubleshooting and monitoring but also ensures that all components are deployed and maintained in a consistent manner across regions.

The subject matter of the present disclosure will now be described more fully hereinafter with reference to the accompanying drawings, which form a part hereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

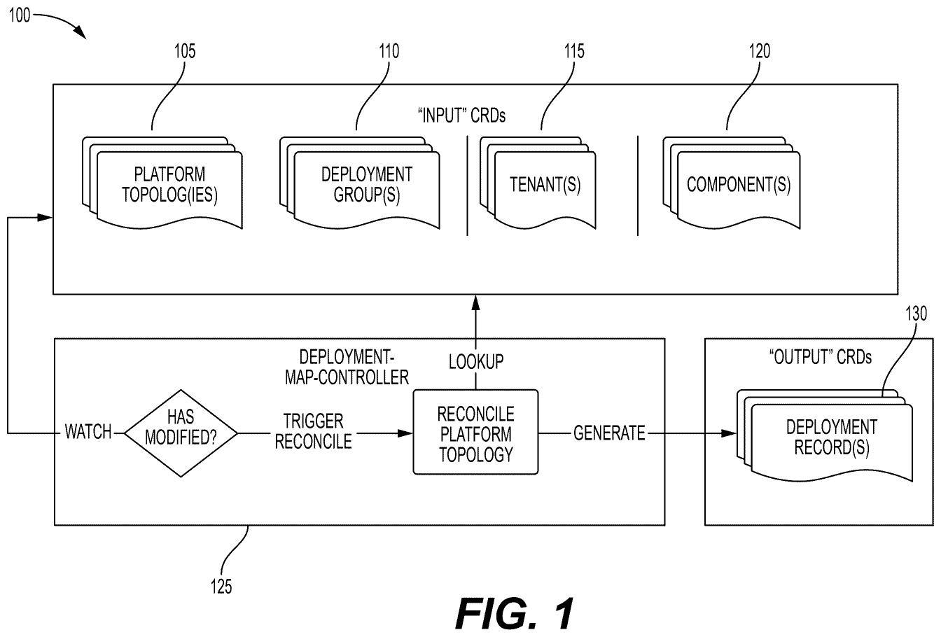

FIG. 1 depicts components of an exemplary deployment map API architecture 100, which is implemented as a Kubernetes-based API using Custom Resource Definitions (CRDs) and a custom Kubernetes controller. The component 125 is configured to manage and automate the creation and reconciliation of deployment records by processing inputs from various CRDs that describe different aspects of the system's infrastructure. In an aspect, the components encompassed by architecture 100 include each of: Input CRDs (e.g., platform topologies CRD 105, deployment groups CRD 110, tenants CRD 115, and components CRD 120), a deployment-map-controller 125, and output CRDs that are represented by deployment records 130. Although each of the foregoing components is included in FIG. 1, in other aspects, a subset of the foregoing components may be utilized.

In an aspect, the input CRDs may represent the key data sources that feed into the deployment map generation process. These CRDs may all be managed by the same team, or different subsets of CRDs may be managed by different teams. Collectively, the input CRDs provide the input that is usable to define, organize, and execute infrastructure deployments in a modular, reusable, and tenant-specific manner.

In an aspect, the platform topology CRD 105 may provide a high-level overview of the system's structure. CRD 120 may define the relationships between various components, their dependencies, and operational configurations. For example, the platform topology CRD 120 may specify how a user authentication service interacts with a database while CRDs 105 and 110 define which cloud regions may be required for deployment. The platform topology input CRDs may serve as the foundational blueprint that enables components to be aligned and operate cohesively within the platform.

In an aspect, the deployment group CRD 110 may be configured to aggregate related deployment records into logical groups to simplify management and improve reusability. For instance, a deployment group may include some or all services, networking routes, and cloud resources usable for a specific geographical region or product feature. By modularizing these components, the deployment group CRD 110 may allow infrastructure teams to reuse and manage these groups efficiently across different deployments, thereby reducing duplication, cost and effort.

In an aspect, the tenant CRD 115 may specify configurations unique to individual tenants or business units in a multi-tenant system. The tenant CRD 115 may also identify specific components required for the tenant to function. Some of these components, for instance, may not be unique to the tenant and not all tenants may need all components. Configurations in CRD 115 may include resource allocations, geographical constraints, or specific service-level agreements (SLAs). For example, one tenant may require deployments in Europe with strict data privacy settings, while another tenant may prioritize performance in North America. The tenant CRD 115 therefore ensures that tenant-specific requirements are accurately captured and incorporated into the deployment process.

In an aspect, the component CRD 120 may incorporate the semantic view, that may represent the reusable building blocks of the system, such as individual services, databases, or APIs. The individual components describe their characteristics, not just dependencies. For example, a service may describe itself as being global or of needing instances per-tenant, per-market, or per-combination-of-tenant and market. The service may further describe itself as needing deployments in every region or only in regions with specific characteristics. For example, a “user profile service” component may advertise that it can be reused across multiple tenants or regions with minimal customization. The component CRD 120 ensures consistency and standardization across deployments by defining these components centrally.

The deployment-map-controller 125 may act as the central coordinator of the system, responsible for ensuring that the actual infrastructure aligns with the intended state described by the input CRDs. In an aspect, the processes facilitated by the deployment-map-controller 125 may operate in a dynamic and automated fashion, continuously adapting to changes in the system's requirements or configurations. More particularly, in an aspect, the deployment-map-controller 125 may continuously monitor (e.g., periodically, continuously, etc.) the input CRDs for any updates or modifications. For example, if a new region is added to the tenant's deployment scope or a component's dependency is updated, the deployment-map-controller 125 may detect this modification (e.g., in real time, on a schedule, etc.). This capability ensures that the system stays responsive and up-to-date with changing requirements with sufficient guardrails for stability. In an aspect, when a modification is detected in any of the input CRDs, the deployment-map-controller 125 may initiate the reconciliation process. This step removes the need for manual intervention by ensuring that updates are handled automatically and systematically. For instance, if a tenant's requirements evolve to include a new service, the deployment-map-controller 125 may trigger a reconciliation to incorporate this change into the deployment records. In an aspect, the reconciliation process may involve interpreting the input CRDs to generate a consistent and accurate deployment map. During this step, the deployment-map-controller 125 cross-references the platform topology (e.g., the high-level structure of the system) with the specific deployment requirements from tenants, components, and deployment groups. For example, if the service configuration specifies dependencies between a user authentication service and a database, the deployment-map-controller 125 ensures that these relationships are respected and that all needed components are included in the deployment in all appropriate regions. The result of the reconciliation process is represented by the deployment records 130, which are generated as output CRDs. These deployment records 130 provide detailed, actionable specifications for infrastructure deployment, such as the exact configuration of Kubernetes clusters, networking routes, and cloud resources. These records may be utilized by automation pipelines to execute the deployment.

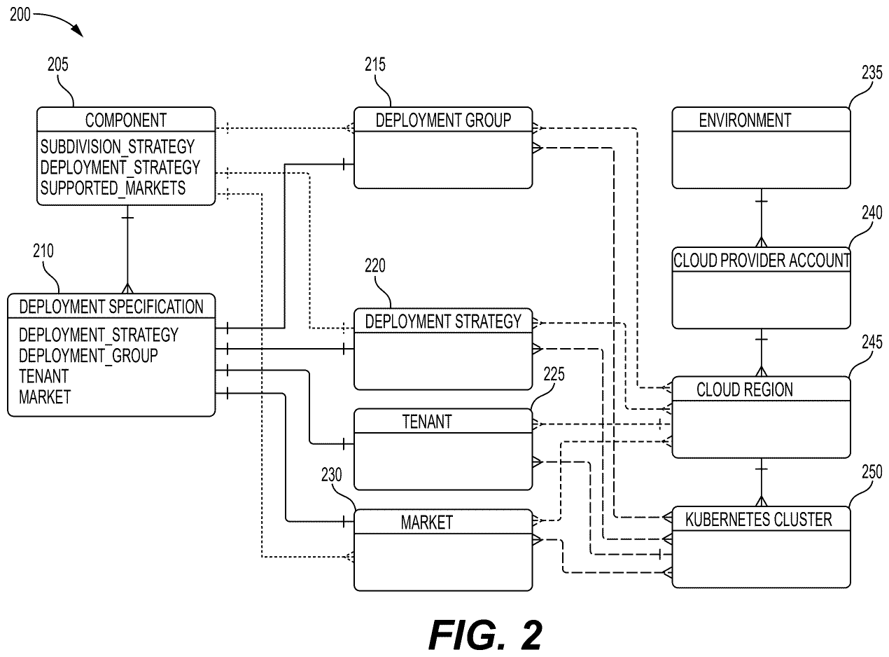

Referring now to FIG. 2, diagram 200 illustrates the relationships and dependencies between various entities modeled using the CRDs within the deployment map API system. More particularly, diagram 200 shows how high-level requirements (e.g., tenants, markets, deployment strategies) are linked to specific infrastructure components and cloud resources. This structure enables the system to dynamically generate deployment specifications and manage complex, multi-tenant, and geographically distributed environments efficiently. By modeling these relationships, the system ensures consistency, modularity, and adaptability across various deployment scenarios.

In an aspect, the component entity 205 may represent the reusable building blocks of the system, such as the specific services or resources. The component entity 205 may include attributes such as subdivision strategy (e.g., which determines how the component may be split or allocated), the deployment strategy (e.g., which defines how and where it should be deployed), and the supported markets (e.g., which specify the geographical regions where the component may operate. In an aspect, the deployment specification entity 210 may act as a bridge between the high-level deployment strategy and specific configurations, incorporating parameters such as the deployment strategy, deployment group, tenant, and market. The deployment specification entity 210 may tie the components to the other entities in the model and ensures that each component is deployed according to the specific strategy and requirements. The deployment group 215 aggregates related components into logical clusters that simplify management and reuse. For example, a deployment group may represent, but is not limited to, all services required for a specific tenant or market or domain or specific deployment cluster. These groups may be connected to both components and environments, linking the logical organization of infrastructure with its physical deployment. Alternatively, in another aspect, deployment groups may contain components without physical environment information but may be linked to the physical deployment via deployment specification. The deployment strategy entity 220 may define the overarching approach for deploying infrastructure, such as prioritizing latency, cost, or geographic proximity. It works in conjunction with deployment specifications to ensure that each deployment aligns with the system's objectives and constraints. Diagram 200 also presents various entities, such as the tenant 225 (e.g., representing specific clients of business units in a multi-tenant system, capturing unique requirements for each tenant), market 230 (e.g., reflecting geographical regions or target markets, ensuring that deployments cater to localized needs), and environment 235 (e.g., which encapsulates the technical infrastructure, such as cloud accounts, regions, and Kubernetes clusters, required to host the deployment in various PROD and sub-prod environments). Diagram 200 further connects these entities to specific cloud resources, such as Cloud Provider accounts 240, Cloud regions 245, and Kubernetes clusters 250.

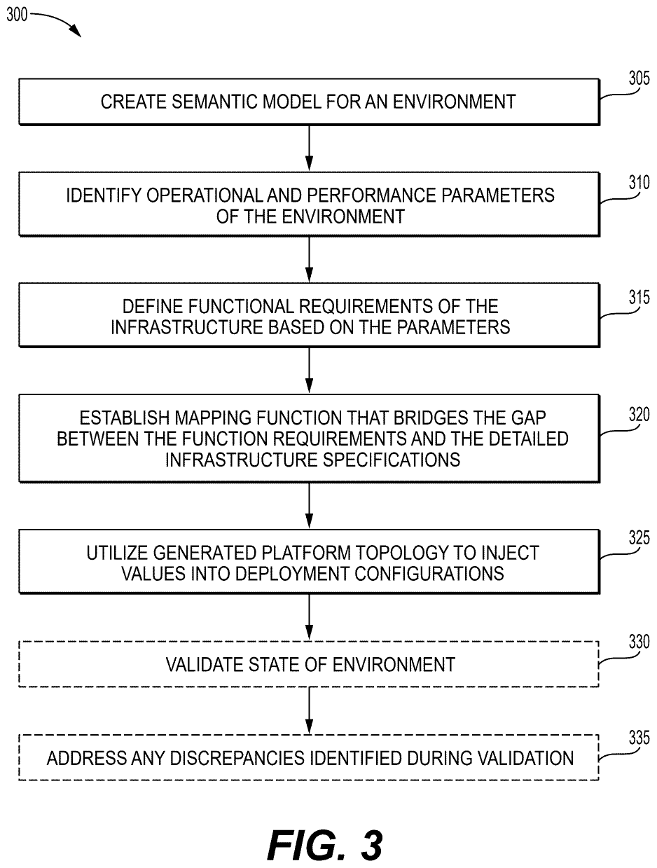

Referring now to FIG. 3, an exemplary process flow 300 is described for implementing a high-level semantic model for infrastructure configuration. Aspects of the exemplary process flow 300 may be performed in accordance with some or all components described in FIGS. 1 and 2.

At step 305, a top-down semantic model may be created for an environment that establishes a structured framework to define and manage infrastructure requirements. This step may first involve identifying the highest level of abstraction that is relevant to the given environment. For instance, in a business-to-consumer (B2C) context, the product itself, such as a streaming service, may represent the top-level abstraction. In a business-to-business (B2B) scenario, domains that cater to different client needs may serve as the top-level abstraction. Similarly, for environments driven by financial performance, business units or profit-and-loss (P&L) line items may be used as the highest abstraction level. This flexibility ensures that the model aligns with the operational and strategic priorities of the specific environment.

Once the top-level abstraction is established, an optimization function may be defined that determines the preferred level of granularity in the model. This optimization function may consider key factors that are pertinent to the environment, such as user experience, system performance, or operational simplicity. For example, if optimizing for user experience, the model may prioritize larger, cohesive units that deliver standalone value, such as an entire streaming product or business unit. On the other hand, if performance or execution speed is critical, the model may drill down into smaller, more granular components like specific services or configurations to optimize efficiency. Importantly, the semantic model may be designed to be flexible, allowing users to switch between higher and lower levels of abstraction as needed. This enables users to manage complexity while retaining control over the system's granularity.

The top-level abstraction may then be systematically broken down into reusable sub-components based on the optimization criteria. In an aspect, sub-components may represent the building blocks of the system, such as individual domains, services, or P&L line items. Each sub-component may be identified and categorized to align with the overarching goals defined in the optimization function. For instance, in a streaming service, sub-components may include user authentication services, content delivery networks, and advertising platforms. This decomposition creates a functional breakdown of the system, allowing each piece to be managed independently while maintaining its relationship to the larger system. This breakdown provides a clear map of how the system operates at various levels of detail, enabling teams to focus on their specific areas of expertise without needing to understand the entire infrastructure. It also establishes a common language for describing system components, thereby bridging the gap between service and infrastructure teams.

At step 310, the operational and performance parameters of the environment may be identified. These parameters are important for tailoring the infrastructure configuration to meet specific needs. In an aspect, this process may involve analyzing the environment's requirements to determine critical parameters that influence the functionality and performance of the system. For instance, in a production environment, low latency is often a primary concern, necessitating careful consideration of geographical markets where requests may be serviced. The system must accommodate regional variations in demand and ensure that services are deployed optimally across appropriate locations. These parameters may therefore be utilized in defining how the system's sub-components, identified in the semantic model, may efficiently service requests across different partitions of the target markets.

In an aspect, the operational parameters may also account for more granular aspects of the system, such as tenant isolation and deployment patterns. Tenant isolation ensures that resources and configurations are segregated to maintain security, data, integrity, and performance consistency for each tenant or product within a multi-tenant system. Deployment patterns may consider failover strategies to ensure high availability and reliability, particularly in critical environments where downtime is not acceptable. For example, if a service in a primary region fails, traffic must seamlessly reroute to a backup region without impacting end-user experience. These patterns and configurations require precise articulation to meet both functional and performance requirements.

In an aspect, to manage these parameters effectively, the system may tag them at different levels of granularity. For instance, sub-component-level parameters, such as latency thresholds, resource limits, or tenant-specific configurations, may be associated directly with the relevant sub-components. This approach avoids repetition by isolating these parameters in a separate abstraction layer or within the tenant configuration. For example, latency requirements for a user authentication service may be tagged directly to that service, ensuring the configuration is modular and reusable. Conversely, environment-level parameters, such as geographical distribution or failover configurations, may be included in the tenant configuration itself. This inclusion may provide the necessary visibility for each of use and ensures that all relevant details are centralized in a single, coherent view. By doing so, the system maintains a clear hierarchy of parameters, allowing operational and performance requirements to be specified and managed at the appropriate levels.

At step 315, the functional requirements of the infrastructure may be defined based on consolidating the functional breakdown from the semantic model (from step 305) and the identified operational and performance parameters (from step 310). This synthesis may create a detailed and actionable specification for configuring the infrastructure, referred to as the tenant configuration. In an aspect, the tenant configuration may act as a blueprint that encapsulates all details for deploying and managing infrastructure components in alignment with the intended operational and performance goals.

At this stage, the focus shifts to translating high-level functional descriptions into precise requirements. For example, consider a scenario where the system needs to deploy a user service across primary cloud regions in the United States and Europe. The tenant configuration captures this deployment requirement, specifying not only the geographical distribution but also the associated parameters such as latency thresholds, failover strategies, and any tenant-specific customization. The functional breakdown provides the hierarchical structure of components and sub-components, while the operational parameters add certain details, such as the environments in which these components will operate (e.g., production, staging, or testing). In an aspect, performance parameters may further refine the specifications by dictating resource allocations, scaling policies, and network configurations needed to meet defined service-level objections (e.g., low latency or high throughput).

At step 320, a mapping function may be established that bridges the gap between the high-level functional, operational, and performance parameters outlined in the tenant configuration and the detailed infrastructure specifications required for deployment. In an aspect, this mapping function may serve as the core mechanism for translating abstract requirements into actionable, technical infrastructure configurations.

In an aspect, the implementation of the mapping function may take various forms. In one aspect, the mapping function may be implemented via Kubernetes custom resource definitions (CRDs), which extend Kubernetes functionality to define custom resources representing the infrastructure specifications. Additionally or alternatively, in another aspect, the mapping function may be implemented via standalone modules or services, whereby independent software components handle parsing and translating the tenant configuration. Additionally or alternatively, in yet another aspect, the mapping function may be implemented via applications or look-up tables, which may include tools or databases that stored predefined mappings for common configurations, allowing rapid translation.

In an aspect, the mapping function may be configured to interpret the tenant configuration by parsing the functional breakdown, operational constraints, and performance requirements, then generate corresponding infrastructure specifications. These specifications may detail important deployment parameters, such as the environment type (e.g., production or staging), cloud accounts, geographical regions, and Kubernetes clusters (e.g., Elastic Kubernetes Service (EKS) clusters). For example, a requirement to “deploy the user service in primary cloud regions in the US and EMEA” may be mapped to a specific technical configuration such as deploying the service in US-EAST1 and EU-WEST2 cloud regions within a defined cloud account. This translation may be recursive, meaning that it accounts for dependencies among components, ensuring that all underlying resources required for the user service (e.g., such as databases, networking configurations, authentication services, etc.) may be similarly translated and included in the deployment plan.

The result of the foregoing process generates a deployment map, which is a comprehensive representation of how the infrastructure may be deployed. In an aspect, the deployment map may be encapsulated in a platform topology, which is a detailed blueprint of the physical and logical deployment of the system. This topology ensures clarity and consistency across the infrastructure, allowing for seamless deployment and management.

In an aspect, several optional features may enhance the flexibility and usability of the mapping function. For instance, in one aspect, the infrastructure specifications may be aggregated into deployment groups. This process may involve logically organizing infrastructure specifications into cohesive units, such as deployment clusters, networking routes, or resource pools. This approach simplifies infrastructure management by grouping related configurations, making it easier to manage and reuse them across different deployments or environments. For example, a deployment group may include all resources needed to support a specific region, such as compute instances, databases, and networking configurations, ensuring consistency across deployments.

Additionally or alternatively, as another example, the semantic specification may be human readable along with being consumable by automation. More particularly, the semantic specifications of service characteristics may ensure that the specific infrastructure configurations generated by the mapping function are not only consumable by automation tools, but are also understandable to human operators. This dual usability facilities validation, debugging, and communication among teams. For example, instead of service operated needing to have knowledge of platform topology or cryptic machine-only code, the configuration may describe a deployment in plain language, such as “deploy user authentication service to handle global traffic with appropriate latency threshold for local and remote calls and the generated configuration will have the specific configuration details determined by the deployment controller that will be available for human operator review.”

Additionally or alternatively, as another example, different configurations may be aggregated for different deployment strategies. In an aspect, supporting multiple deployment strategies may enable the system to accommodate diverse operational requirements, such as primary cloud regions for high-priority workloads versus replica regions for backup or disaster recovery. For instance, a service may be deployed with high availability in US-EAST1 and EU-WEST2 as primary regions while maintaining replicas in US-WEST1 for redundancy. This flexibility enables organizations to optimize infrastructure for cost, performance, and resilience, adapting to the specific needs of each deployment scenario while ensuring operational continuity.

Additionally or alternatively, as another example, the EKS clusters may be aggregated by geography or tenant. More particularly, cluster aggregation by geography or tenant organizes Kubernetes clusters or other resources based on their geographical location or the specific tenant they serve. This approach may facilitate targeted resource allocation, ensuring that infrastructure aligns with market demands or tenant-specific requirements. For example, clusters in North America may be optimized for latency-sensitive applications, while clusters for a specific tenant may include additional isolation and custom configurations. As another example, data localization requirements might require or prohibit hosting data for some users in specific countries or regions.

Additionally or alternatively, as another example, networking routes may be aggregated based on a traffic partitioning strategy. In an aspect, traffic partitioning enables the dynamic routing of network traffic based on parameters such as source, destination, or other predefined criteria. This capability supports advanced traffic management strategies, including load balancing, failover, and geographical routing. For instance, traffic from Europe may be routed to EU-WEST2, while North American traffic may be directed to US-EAST1. Partitioning allows for redirection of traffic during outages or scaling events, ensuring consistent performance and availability.

At step 325, the generated platform topology may be utilized to inject relevant values into deployment configurations that may define and manage the deployment pipeline for components and their underlying cloud resources. In an aspect, Helm charts, which serve as a powerful tool in Kubernetes environments, provide a declarative way to describe, configure, and manage applications. To integrate the platform topology, these charts may undergo templatization, which may involve structuring them with placeholders or variables that may be dynamically populated with specific values during deployment. For example, a Helm chart for deploying a user authentication service may include placeholders for regions, resource limits, and network configurations, which are populated using data from the platform topology.

In an aspect, instead of generating entire Helm charts from scratch, this approach focuses on mapping requirements, characteristics and desired states to produce the set of deployment records describing the system in the ideal state and uses config injection to inject the determined values into deployment templates and match the system to the desired configuration. More particularly, by determining the set of targets that should exist and injecting pertinent values into pre-existing templates to produce them, the system minimizes complexity while retaining flexibility. For instance, the service may specify separate configurations for high vs moderate load. The topology might indicate that a US-EAST1 and EU-WEST2 are high traffic regions while US-EAST2 is low traffic. The deployment engine may produce templates for US-East1 and EU-West2 injected with the correct values. In an aspect, this modular approach allows for rapid adaptation to changes in the topology without requiring extensive rework of the underlying charts. In an aspect, the injection process also supports the integration of underlying cloud resources by injecting their specific parameters into the deployment pipeline.

At optional step 330, the state of the environment may be validated to ensure that the deployed infrastructure aligns precisely with the intended design described in the platform topology. In an aspect, the validation process may involve regenerating the platform topology from the tenant configuration. This regeneration ensures that the latest function requirements, operational parameters, and performance criteria are accurately reflected in the topology. Essentially, the platform topology serves as the “expected state” of the environment—a blueprint detailing how the infrastructure may look and behave. This includes information about deployed services, resource allocations, network configurations, regions, and any other relevant deployment specifications. Next, the actual state of the deployed environment may be assessed by querying the infrastructure components. This assessment involves gathering real-time data on the deployed services, their configurations, resource utilization, and dependencies. The actual deployment state may then be compared against the expected state defined in the platform topology.

At optional step 335, any discrepancies between the deployed infrastructure may be flagged for review, as they may indicate misconfigurations, missing components, or deviations from the intended setup. For example, if the deployment record specifies that a user service should be deployed in US-EAST1 with a large configuration and EU-WEST2 with a medium configuration, but the actual deployment reveals that the service is missing from one region or has an incorrect allocation of only 2 GB, the reconciliation process may identify these mismatches. In an aspect, these findings may then be addressed by either adjusting the actual deployment to match the topology or by refining the tenant configuration and mapping function to ensure correctness.

Accordingly, the method described herein may be configured to automate the entire process of setting up and deploying cloud infrastructure using a structured, intelligent approach. First, the system may define a semantic model, which acts as a high-level blueprint outlining what services, resources, and configurations are needed based on business and technical requirements. It then translates this model into detailed infrastructure specifications, determining exactly which cloud resources (e.g., such as databases, compute instances, and networking components) are required. From these specifications, the system my generate a deployment map, which serves as a structured plan that defines where and how the infrastructure should be deployed, ensuring consistency across different environments. Once the deployment map is created, the system may break it down into deployment records, which specify, e.g., the exact components that need to be created, the configuration templates to use, and the values that must be inserted. These templates may contain placeholders, and the system may automatically fill in these placeholders with the correct values (e.g., such as region settings, resource limits, security policies, etc.). Thereafter, the system may execute the deployment process, provisioning and configuring all necessary cloud resources without requiring manual intervention. By automating these steps, the system eliminates the need for manual infrastructure setup, reduces human error, and allows for scalable, repeatable deployments.

As a non-limiting example of the foregoing process, a company may be launching a new e-commerce platform that needs to be deployed in multiple regions while ensuring high availability, security, and compliance with local regulations. Traditionally, engineers would have to manually determine which cloud resources are needed, configure them, and write deployment scripts. The concepts described herein automate this entire process by defining a semantic model that captures high-level requirements, such as “deploy a web service in the U.S. and Europe with GDPR-compliant storage.” The system may then translate these requirements into infrastructure specifications, determining the exact cloud resources needed (e.g., such as a cloud database in US-EAST1 and EU-WEST1, Kubernetes clusters for hosting the application, and a specific CDN for content delivery). From these specifications, the system may generate a deployment map, which acts as a blueprint outlining how all components should be deployed and interconnected. The system may then create deployment records that specify each infrastructure component, the deployment template to use, and placeholders for configurable parameters. These placeholders (e.g., “REGION,” “DB_TYPE,” or “CPU LIMIT,”) may then be automatically populated with real values from the deployment map. Finally, the system may execute the deployment process, provisioning and configuring the cloud infrastructure without requiring human intervention.

In general, any process discussed in this disclosure that is understood to be computer-implementable, such as the processes illustrated in FIG. 3, may be performed by one or more processors of a computer system. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer server. A processor may be a central processing unit (CPU), a graphics processing unit (GPU), or any suitable type of processing unit.

A computer system may include one or more computing devices. If the one or more processors of the computer systems are implemented as a plurality of processors, the plurality of processors may be included in a single computing device or distributed among a plurality of computing devices. If any computer systems comprise a plurality of computing devices, the memory of the computer systems may include the respective memory of each computing device of the plurality of computing devices.

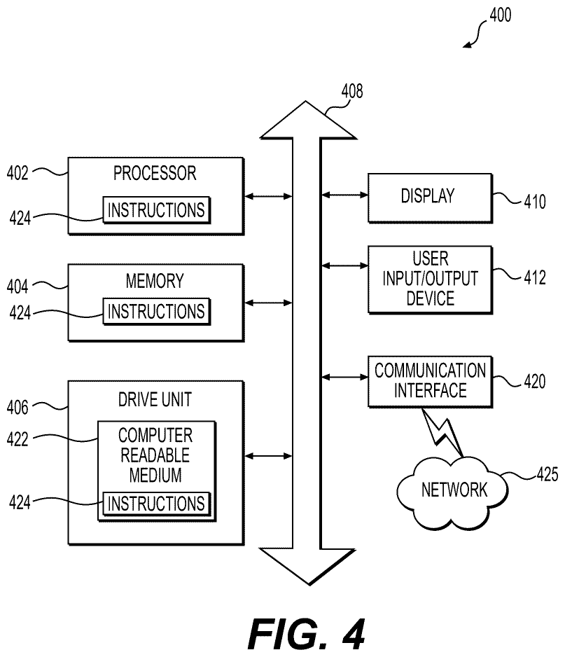

FIG. 4 is a simplified functional block diagram of a computer system 400 that may be configured as a computing device for executing the process illustrated in FIG. 3, according to exemplary embodiments of the present disclosure. In various embodiments, any of the systems herein may be an assembly of hardware including, for example, a communication interface 420 for packet data communication. The system also may include a central processing unit (“CPU”) or processor 402, in the form of one or more processors, for executing program instructions. The system may include an internal communication bus 408, and a drive unit 406 (such as ROM, HDD, SDD, etc.) that may store data on a computer readable medium 422, although the system 400 may receive programming and data via network communications via electronic network 425 (e.g., voice, video, audio, images, or any other data over the electronic network 425). The system 400 may also have a memory 404 (such as RAM) storing instructions 424 for executing techniques presented herein, although the instructions 424 may be stored temporarily or permanently within other modules of system 400 (e.g., processor 402 and/or computer readable medium 422). The system 400 also may include input and output device 412 and/or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

In general, any process discussed in this disclosure that is understood to be performable by a computer may be performed by one or more processors. Such processes include, but are not limited to: the process shown in FIG. 3, and the associated language of the specification. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. The instructions also may be stored on a non-transitory computer-readable medium. The non-transitory computer-readable medium may be separate from any processor. Examples of non-transitory computer-readable media include solid-state memories, optical media, and magnetic media.

In the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for automating a configuration and deployment of infrastructure using a semantic model, the computer-implemented method comprising operations including:
defining, using a computer system, the semantic model;
translating, using a processor associated with the computer system, the semantic model into infrastructure specifications;
generating, using the processor and from the infrastructure specifications, a deployment map representing a platform topology of physical deployments and characteristics of the physical deployments;
generating, using the processor and based on the deployment map, a sequence of deployment records, wherein each of the sequence of deployment records indicate a desired target component, a template, and one or more parameters to be inserted into one or more positions in a deployment template to reach a target outcome;
inserting, using the processor, one or more configuration values derived from the sequence of deployment records into the one or more positions in the deployment template; and
automating, based on the inserting, the deployment of the infrastructure.

2. The computer-implemented method of claim 1, wherein the infrastructure specifications include one or more: environment type designations, cloud regions, routing rules, firewall settings, data partitioning, and traffic partitioning strategies.

3. The computer-implemented method of claim 1, further comprising dynamically modifying the deployment map based on changes in one or more operational parameters, including: traffic patterns, resource utilization, latency, failure conditions or recovery patterns.

4. The computer-implemented method of claim 1, wherein the inserting comprises replacing one or more mapping placeholder fields in the deployment template with values derived from the sequence of deployment records.

5. The computer-implemented method of claim 1, wherein the one or more configuration values correspond to one or more of: region-specific settings, failover policies, and service-level agreements (SLAs).

6. The computer-implemented method of claim 1, further comprising validating a state of the infrastructure by comparing the deployment map against the infrastructure.

7. The computer-implemented method of claim 6, wherein the validating further comprises flagging, responsive to identifying at least one discrepancy between the deployment map and the infrastructure, the at least one discrepancy.

8. The computer-implemented method of claim 7, further comprising rectifying the state of the infrastructure by creating, replacing, updating or deleting cloud resources and/or service configurations to address the at least one discrepancy.

9. The computer-implemented method of claim 1, further comprising generating, responsive to identifying the deployment template does not support configurations defined in the deployment map, one or more new deployment templates.

10. The computer-implemented method of claim 1, further comprising providing a user interface to visualize and edit the semantic model.

11. A system comprising:
a memory including instructions; and
at least one processor configured to execute the instructions stored in the memory to perform operations comprising:
defining a semantic model;
translating the semantic model into infrastructure specifications;
generating, from the infrastructure specifications, a deployment map representing a platform topology of physical deployments and their characteristics;
generating, based on the deployment map, a sequence of deployment wherein each of the sequence of deployment records indicate a desired target component, the template, and the parameters to be inserted to reach a target outcome;
inserting one or more configuration values derived from the deployment record into one or more positions in a deployment template; and
automating, based on the deployment template, deployment of the infrastructure.

12. The system of claim 11, wherein the infrastructure specifications include one or more: environment type designations, cloud regions, routing rules, firewall settings, data partitioning, and traffic partitioning strategies.

13. The system of claim 11, wherein the instructions are further executable by the at least one processor to perform operations comprising:
dynamically modifying the deployment map based on changes in one or more operational parameters, including: traffic patterns, resource utilization, latency, failure conditions, or recovery patterns.

14. The system of claim 11, wherein the instructions for inserting are further executable by the at least one processor to perform operations comprising:
replacing one or more mapping placeholder fields in the deployment template with values derived from the sequence of deployment records.

15. The system of claim 11, wherein the one or more configuration values correspond to one or more of: region-specific settings, failover policies, and service-level agreements (SLAs).

16. The system of claim 11, wherein the instructions are further executable by the at least one processor to perform operations comprising:
validating a state of the infrastructure by comparing the deployment map against the infrastructure.

17. The system of claim 16, wherein the instructions for validating are further executable by the at least one processor to perform operations comprising:
flagging, responsive to identifying at least one discrepancy between the deployment map and the infrastructure, the at least one discrepancy.

18. The system of claim 17, wherein the instructions are further executable by the at least one processor to perform operations comprising:
rectifying the state of the infrastructure by creating, replacing, updating, or deleting cloud resources and/or service configurations to address the at least one discrepancy.

19. The system of claim 11, wherein the instructions are further executable by the at least one processor to perform operations comprising:
generating, responsive to identifying the deployment template does not support configurations defined in the deployment map, one or more new deployment templates.

20. A non-transitory computer-readable medium storing computer-executable instructions that, when executed by a server in network communication with at least one database, cause the server to perform operations comprising:
defining, using a computer system, a semantic model;
translating, using a processor associated with the computer system, the semantic model into infrastructure specifications;
generating, using the processor and from the infrastructure specifications, a deployment map representing a platform topology of physical deployments and characteristics of the physical deployments;
generating, using the processor and based on the deployment map, a sequence of deployment records, wherein each of the sequence of deployment records indicate a desired target component, a template, and one or more parameters to be inserted into one or more positions in a deployment template to reach a target outcome;
inserting, using the processor, one or more configuration values derived from the sequence of deployment records into the one or more positions in the deployment template; and
automating, based on the inserting, the deployment of the infrastructure.
